(19) United States
(12) Patent Application Publication
(10) Pub. No.: US 2025/0105913 A1
(43) Pub. Date: Mar. 27, 2025

(54) NON-TERRESTRIAL NETWORKS WITH STORE AND FORWARD

(71) Applicant: APPLE INC., Cupertino, CA (US)

(72) Inventors: Yuqin Chen, Beijing (CN); Haijing Hu, Los Gatos, CA (US); Ping-Heng Kuo, London (GB); Naveen Kumar R. Palle Venkata, San Diego, CA (US); Fangli Xu, Beijing (CN); Alexander Sirotkin, Tel Aviv (IL); Peng Cheng, Beijing (CN); Zhibin Wu, Los Altos, CA (US); Ralf Rossbach, Munich (DE)

(73) Assignee: APPLE INC., Cupertino, CA (US)

(21) Appl. No.: 18/814,362

(22) Filed: Aug. 23, 2024

Related U.S. Application Data
(60) Provisional application No. 63/540,165, filed on Sep. 25, 2023.

(51) Int. Cl. H04B 7/185; H04W 48/16; H04W 76/10

(52) U.S. Cl. CPC H04B 7/18513; H04W 48/16; H04W 76/10

(57) ABSTRACT

The present application relates to devices and components, including apparatus, systems, and methods for non-terrestrial networks with store and forward operation.

### CROSS-REFERENCES TO OTHER APPLICATIONS

This application claims priority to U.S. Provisional Application No. 63/540,165, for “NON-TERRESTRIAL NETWORKS WITH STORE AND FORWARD,” filed on Sep. 25, 2023, which is herein incorporated by reference in its entirety for all purposes.

### TECHNICAL FIELD

This application generally relates to non-terrestrial wireless communication networks, particularly technologies for storing and forwarding data to or from user equipment.

### BACKGROUND

Non-terrestrial networks (NTN) may refer to using satellite and aerial, e.g., high altitude platform station systems, to provide telecommunications services as part of a communication network, e.g., wireless cellular networks. NTN may be used to extend network coverage to remote and underserved areas and provide additional capacity and resilience.

### BRIEF DESCRIPTION OF THE DRAWINGS

FIG. 1 illustrates a network environment in accordance with some embodiments.

FIG. 2 illustrates network environments in accordance with some embodiments.

FIG. 3 illustrates a network environment in accordance with some embodiments.

FIG. 4 illustrates system requirements in accordance with some embodiments.

FIG. 5 illustrates a signaling diagram in accordance with some embodiments.

FIG. 6 illustrates a signaling diagram in accordance with some embodiments.

FIG. 7 illustrates a signaling diagram in accordance with some embodiments.

FIG. 8 illustrates a signaling diagram in accordance with some embodiments.

FIG. 9 illustrates a network environment in accordance with some embodiments.

FIG. 10 illustrates a signaling diagram in accordance with some embodiments.

FIG. 11 illustrates a signaling diagram in accordance with some embodiments.

FIG. 12 illustrates a signaling diagram in accordance with some embodiments.

FIG. 13 illustrates a signaling diagram in accordance with some embodiments.

FIG. 14 illustrates a signaling diagram in accordance with some embodiments.

FIG. 15 illustrates an operational flow/algorithmic structure in accordance with some embodiments.

FIG. 16 illustrates an operational flow/algorithmic structure in accordance with some embodiments.

FIG. 17 illustrates a user equipment in accordance with some embodiments.

FIG. 18 illustrates a network node in accordance with some embodiments.

### DETAILED DESCRIPTION OF THE INVENTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

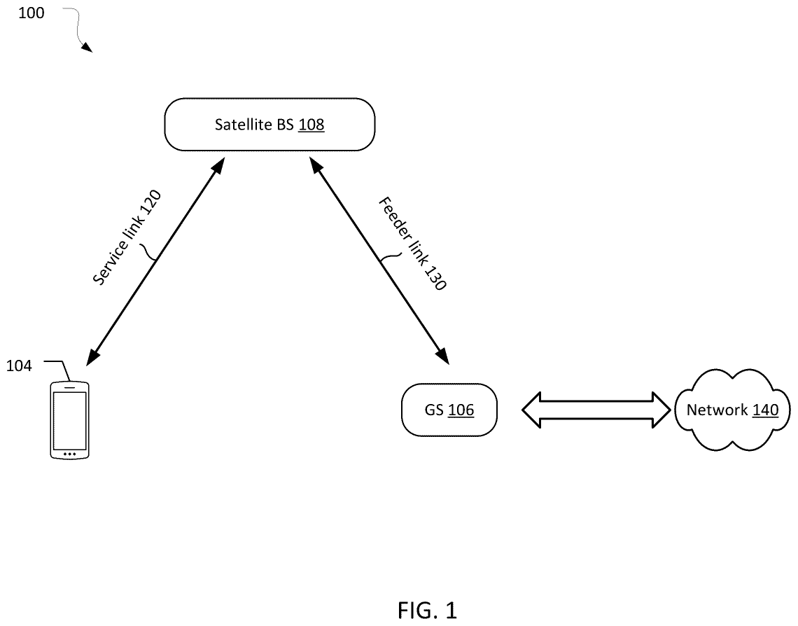

FIG. 1 illustrates a network environment 100 in accordance with some embodiments. The network environment 100 may include a UE 104 coupled with a satellite base station (BS) 108 of a radio access network (RAN). In some embodiments, the satellite BS 108 is a next-generation node B (gNB) that provides one or more 3GPP New Radio (NR) cells. In other embodiments, the satellite BS 108 is an evolved node B (eNB) that provides one or more Long Term Evolution (LTE) cells. The air interface over which the UE 104 and the satellite BS 108 communicate may be compatible with 3GPP technical specifications (TSs), such as those that define Fifth Generation (5G) NR or later system standards (e.g., Sixth Generation (6G) standards).

The satellite BS 108 may be coupled with a ground station (GS) 106. The air interface over which the satellite BS 108 and the GS 106 communicate may be compatible with 3GPP TSs, such as those that define 5G NR or later system standards, e.g., 6G standards.

The GS 106 may be a gateway to a network 140, e.g., the Internet. The network 140 may be an external network or an Internet of Things (IoT) service endpoint, e.g., an IoT application server.

Herein, an uplink (UL) transmission may mean any transmission that carries the data from the UE 104 to the network 140, e.g., a transmission from the UE 104 to the satellite BS 108 via a service link 120, a transmission from the satellite BS 108 to the GS 106 via a feeder link 130, or a transmission from the GS 106 to the network 140. Similarly, a downlink (DL) transmission may mean any transmission that carries the data from the network 140 to the UE 104, e.g., a transmission from the network 140 to the GS 106, a transmission from the GS 106 to the satellite 108 via the feeder link 130, or a transmission from the satellite 108 to the UE 104 via the service link 120.

The satellite BS 108 may operate in a transparent mode. In transparent mode, the satellite BS 108 may act as a repeater. The satellite BS 108 may perform frequency conversion and amplification. The satellite BS 108 in transparent mode may receive an UL transmission from the UE 104 via the service link 120 and retransmit it to the GS 106 via the feeder link 130. Similarly, the satellite BS 108 may receive a DL transmission from the GS 106 via the feeder link 130 and retransmit it to the UE 104 via the service link 120.

The satellite BS 108 may operate in a regenerative mode. In regenerative mode, the satellite BS 108 may perform baseband processing. The satellite BS 108 in regenerative mode may support all or some of the functionalities of a radio access network (RAN), an access stratum (AS), or a non-access stratum (NAS). The satellite BS 108 in regenerative mode may support all or some of the functionalities of a core network (CN). For example, the satellite BS 108 may support some or all functionalities of a user plane function (UPF) or an access and mobility management function (AMF).

In regenerative mode, the satellite BS 108 may perform baseband processing. The satellite BS 108 may receive an UL transmission from the UE 104 on the service link 120 and perform demodulation and decoding on the received signals. The satellite BS 108 may re-encode or modulate the data for transmission to GS 106 via feeder link 130. Similarly, the satellite BS 108 may receive a DL transmission from the GS 106 and perform demodulation and decoding on the received signals. The satellite BS 108 may re-encode or modulate the data for transmission to the UE 104 via the service link 120.

In some instances, the satellite BS 108 in regenerative mode may perform the functions of a central unit (CU). The CU may be a logical node. The CU may perform the functionalities of a gNB or an eNB. For example, the CU may perform mobility control, radio access network sharing, positioning, session management, or user data transfer. The CU may perform medium access control layer (MAC layer, layer 2) or the radio resource control (RRC, or layer 3) functions. The CU may be responsible for non-real-time operations of MAC or RRC. The satellite BS 108 in regenerative mode may perform UPF functionalities, e.g., protocol data unit (PDU) session anchor point for providing mobility within and between radio access technologies, packet routing and forwarding, per-flow quality of service (QOS) handling, or inter-networking.

In some instances, the satellite BS 108 in regenerative mode may perform the functions of a distributed unit (DU). The DU may be a logical node. The DU may perform the functionalities of a gNB or an eNB. The DU may be responsible for the real-time operation of the physical layer (PHY) or MAC, e.g., data link layer or scheduling. A CU may control the DU operation.

In some instances, the satellite BS 108 may have an established and active service link 120 with the UE 104 but not the feeder link 130 to the GS 106. For example, the satellite BS 108 may serve the UE 104 in the middle of an ocean without access to the feeder link 130 to the BS 106. In scenarios like this, the satellite BS 106 may operate in a store and forward (S&F) mode. To operate in S&F mode, the satellite BS 106 may be in regenerative mode. S&F mode, when satellite BS 106 is in transparent mode, may require a procedure to associate a received signal to the corresponding transmitting UE.

In an S&F mode, the satellite BS 106 may receive data from the UE 104 through the UL transmissions via the service link 120. The satellite BS 106 may store the data while the feeder link 130 is unavailable. When the satellite BS 106 established (or re-established) a connection to the GS 106 via the feeder link 130, the satellite BS 106 may forward the UE's data to the GS 106.

The S&F mode may provide autonomous service to the UE 104 without the satellite BS 108 always being connected to a gateway. It may enable the service link 120 to continue to be operational when the feeder link 130 is not connected. The satellite BS 108 may operate like a short message service center (SMSC) and store the messages until a feeder link 130 is available. Since the data is being stored by the satellite BS 106 before being forwarded to the GS 106, the S&F mode may be relevant to delay-tolerant IoT services.

In some instances, the cell information such as TAI (tracking area identity), ECGI (evolved universal mobile telecommunications system (UMTS) terrestrial radio access network (E-UTRAN) cell global identifier), or the physical cell identity (PCI) may remain unchanged while the satellite BS 108 is in S&F mode.

When the satellite BS 108 reconnects to a GS, it may reconnect to the same core network (CN) as it was connected to before. In some instances, the satellite BS 108 may connect to a different CN after reconnecting to the GS.

When the satellite BS 108 is in S&F mode, the initial network access procedures for connecting a UE, e.g., the UE 104, to the network may not be feasible. A UE may not perform the initial access operation with a satellite BS in S&F mode, or a satellite BS in S&F mode may reject an initial access request for a UE.

The satellite BS 108 in S&F mode may not have access to the CN, and thus, the procedures involving CN interaction may not be performed. For example, after a random access procedure and cell attachment, the UE may register with the AMF. The registration with AMF may include authentication with the authentication server function (AUSF). The authentication process may also involve interaction with unified data management (UDM), policy control function (PCF), or session management function (SMF) in the core network, which is not accessible while the satellite BS 106 is in S&F mode. Other operations requiring interaction with CN, such as NAS security negotiation or tracking area update (TAU), may not be available to the satellite BS 106 during the S&F mode.

The UE 104 may be able to perform AS layer operations with the satellite BS 108, which the satellite BS 108 is in S&F mode. If the cell ID is not changed, the UE may consider that it is served by the same cell, thus keeping its AS layer context, such as AS security, RRC connection information, carrier aggregation information, dual connectivity information, or system information. For example, the UE may perform RAN-based notification area update (RNAU) or radio link management (RLM). A UE, e.g., the UE 104, in an RRC connected state, may remain in the RRC connected state or transition to an RRC idle or inactive state.

It is desired to enable the UE 104 to send data to the satellite BS 108 when the satellite BS 108 is in S&F mode. In some embodiments, the cellular IoT (CIoT) data transmission over the control plane (CP) or user plane (UP) may be used to transmit data from the UE 104 in RRC idle or inactive state to the satellite BS 108 in S&F mode. The transmission may be performed without CN involvement.

In some embodiments, the CIoT early data transmission (EDT) over the CP and UP may be used to transmit data from the UE 104 in RRC idle or inactive state to the satellite BS 108 in S&F mode. The transmission may be performed without CN involvement.

One example scenario may be the mobile-originated (MO) use case. The UE 104 may be an IoT UE in a remote area, and the satellite BS 108 may provide coverage to the IoT UE 104 while in S&F mode. The IoT UE 104 and the satellite BS 108 may interact over the service link 120, allowing the UE to transfer the messages to the satellite, which has no connectivity to the GS 106. The satellite BS 108 may store the received messages locally. At a later time, when the satellite BS 108 establishes connectivity with the GS 106 via the feeder link 130, it may forward (relay or download) the UE's stored message to the ground network. All accumulated and stored MO messages may be delivered to the GS 106 once the feeder link 130 is available. The GS 106 may deliver messages to the application server based on established connectivity configuration and routing information.

Another example scenario may be the mobile-terminated (MT) use case. An application server may need to send a new configuration to the IoT remote monitoring UE 104. Based on the information provided by the network, the application server may be aware that the communication with the IoT UE 104 is in S&F mode. The application server messages may send the new configuration parameters through dedicated messages by conventional means, e.g., internet protocol (IP) routing or tunnels, to the network entry-point, e.g., service capability exposure function (SCEF), packet data network-gateway (PDN-GW), or short message service center (SMSC). The application server may provide additional information, such as delivery priority or acknowledgment to the network. The network, e.g., the GS 106, may store the messages until they can be delivered (or relayed) to a satellite BS, e.g., the satellite BS 108, that is expected to fly over and provide coverage to the destination IoT remote monitoring UE 104. When the satellite BS 108 is connected to the GS 106 via the feeder link 130, the messages may be uploaded into the satellite BS 108 along with all accumulated and stored mobile terminated messages. When the satellite BS is connected to the IoT remote monitoring UE 104 via the service link 120, the stored message may be delivered or downloaded from the satellite BS 108 to the IoT remote monitoring UE 104, and acknowledgment may be requested or issued by the UE 104.

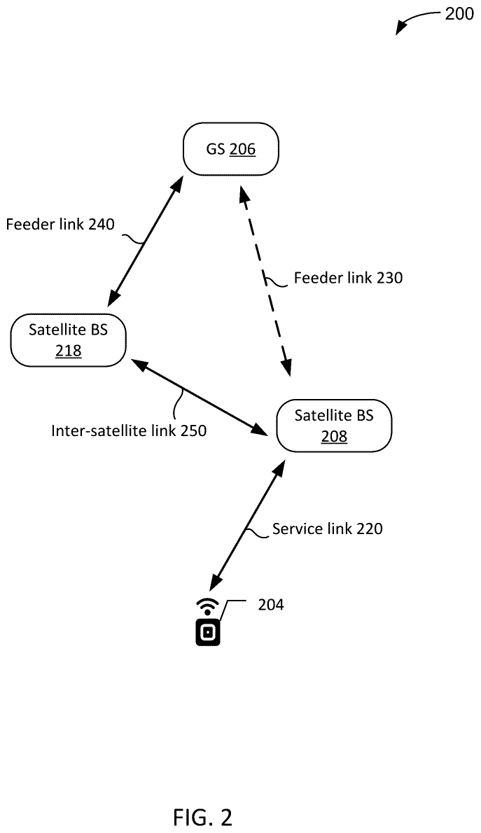

FIG. 2 illustrates network environments 200 in accordance with some embodiments. The network environment 200 is an example use case of S&F mode operation. The network environment 200 may include a UE 204 coupled with the serving satellite BS 208 via the service link 220. Due to a movement of the UE 204 or the satellite 208, the satellite BS 208 feeder link 230 to the GS 206 may be disconnected or not active.

The UE 204 may send data packets to the serving satellite BS 208, even though the serving satellite BS 208 is not connected to the CN. The serving satellite BS 208 may send the UE's data packets to the GS 206 via a satellite BS 218. The serving satellite BS 208 may send the UE's data packets to the satellite BS 218 via an inter-satellite link 250. The satellite Bs 218 may send the UE's data packet to the GS 206 via a feeder link 240.

The serving satellite BS 208 may not be coupled with the satellite BS 218. Therefore, the serving satellite BS 208 may store the UE's data packets until it establishes the inter-satellite link 250 with the satellite BS 218. When the inter-satellite link 250 is established, the serving satellite BS 208 may forward the UE's packet data to the satellite BS 218. The serving satellite BS 208 may forward the UE's packet data to the satellite BS 218 based on an indication that the satellite BS 218 has an active feeder link 240 coupled with the GS 206. The satellite BS 218 may provide information associated with the feeder link 240 or the GS 206 to the serving satellite BS 208 when establishing the inter-satellite link 250.

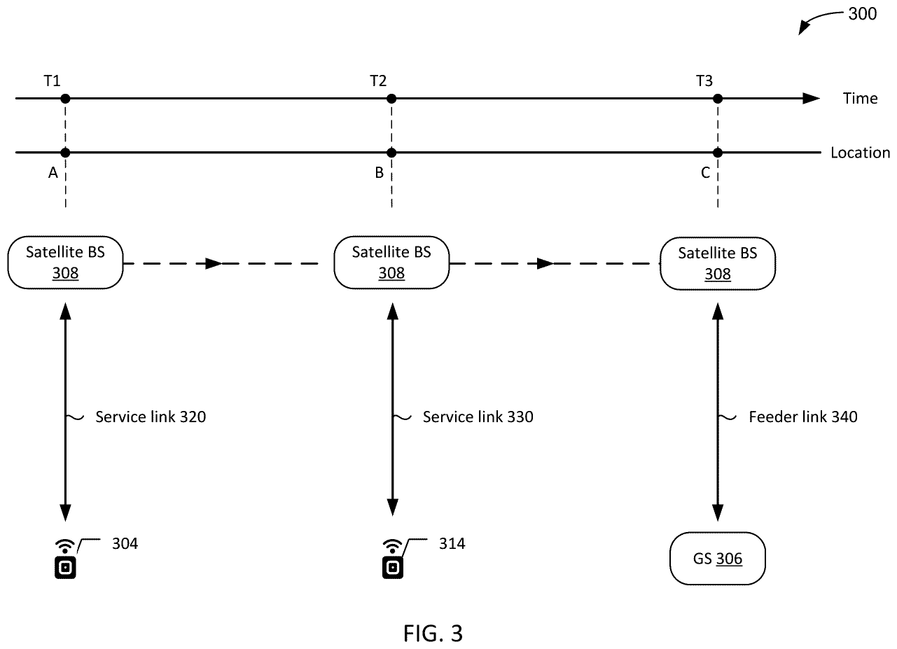

FIG. 3 illustrates a network environment 300 in accordance with some embodiments. The network environment 300 is an example use case of S&F mode operation. The network environment 300 may include a UE 304, a UE 314, a satellite BS 208, and a GS 306. For example, the IoT UEs 304 and 314 may be installed on animals and registered with the network for the S&F satellite operation. The satellite with the S&F function enables the IoT devices to transfer data to the network, even when the feeder link to the GS 306 is not available. A secured connection between the IoT devices 304 and 314 and the satellite 308 may be established to protect data security and privacy.

At time T1, the satellite BS 308 may be at location A and coupled with the UE 304 via an active service link 320. The satellite BS 308 may not have an active feeder link at this time. The UE 304 may send its packet data to the satellite BS 308. The satellite BS 304 may store the UE's packet data. The packet data may include sensor status information.

At time T2, the satellite BS 308 may be at location B and coupled with the UE 314 via an active service link 330. The satellite BS 308 may not have an active feeder link at this time. The UE 314 may send its packet data to the satellite BS 308. The satellite BS 304 may store the UE's packet data. The packet data may include sensor status information.

At time T2, the satellite 308 may be at location C and establish a feeder link 340 with the GS 306. The satellite BS 308 may forward the UEs' packet data, e.g., the sensor status information, as well as other necessary information, to the GS 306. Based on the information received, the ground core network may verify the UE devices. The ground core may forward the UEs' packet data to the destination data network.

The ground core network may send the operation result to a satellite, e.g., the satellite BS 308 or a different one that will pass through the remote area where the UEs are located. When the satellite, e.g., the satellite BS 308 or the other satellite BS, passes through the remote area, the satellite BS may page the UEs 304 and 314. Based on the results received from the ground core network via the GS 306, the satellite BS may send the operation results to the UEs 304 or 314.

If an IoT device, e.g., UEs 304 or 314, needs to send additional information, it may send it to the satellite BS when connected to the satellite BS. The satellite BS may store it and forward it to the GS 306 when the feeder link becomes available.

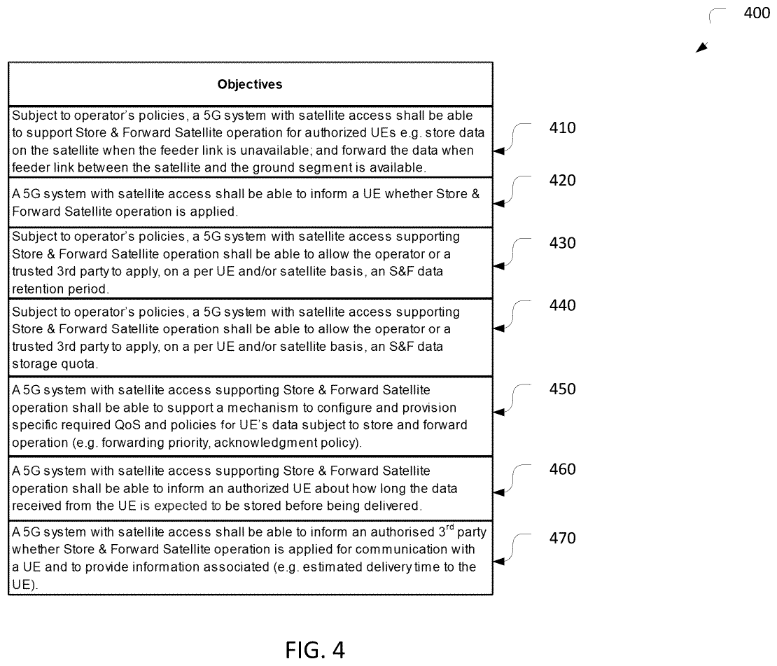

FIG. 4 illustrates system objectives table 400 in accordance with some embodiments. The objectives table 400 may be based on the 3GPP Technical Report (TR) 22.865 version 19.0.0, 2023 Jun. 23.

Objective 410 of the system objectives table 400 may indicate that it may be desire that a system with satellite access supports S&F satellite operation mode for authorized UEs. The S&F satellite operation may include storing the data on the satellite when a feeder link is unavailable and forwarding the data when the feeder link between the satellite and the ground segment, e.g., the GS, is available.

Objective 420 of the system objectives table 400 may indicate that it may be desire that a system with satellite access informs a UE whether S&F satellite operation is applied. For example, when the satellite BS switches from a normal mode operation to an S&F mode operation, the satellite BS may inform one or more of the UEs connected to the satellite BS of the switching or operating in S&F mode.

Objective 430 of the system objectives table 400 may indicate that it may be desire that a system with satellite access supporting S&F satellite operation allows an operator or a trusted 3^{rd} party to apply an S&F data retention period. For example, configuring the satellite BS to store a specific UE's data no longer than a specific time. The retention policy may be per UE basis or per satellite basis. In some examples, the retention policy may be per service data flow (SDF) or quality of service (QOS) flow basis.

Objective 440 of the system objectives table 400 may indicate that it may be desire that a system with satellite access supporting S&F satellite operation allows an operator or a trusted 3^{rd} party to apply, on a per UE or satellite basis, an S&F data storage quota. For example, the satellite may be configured to store up to M bytes of packet data associated with a specific UE.

Objective 450 of the system objectives table 400 may indicate that it may be desire that a system with satellite access supporting S&F satellite operation supports a mechanism to configure and provision specific QoS and policies for UE's data. For example, assigning forwarding priority to packets associated with a specific UE, a specific SDF, or a specific QoS flow.

Objective 460 of the system objectives table 400 may indicate that it may be desire that a system with satellite access supporting S&F satellite operation informs an authorized UE about how long the data received from the UE is expected to be stored before being delivered.

Objective 470 of the system objectives table 400 may indicate that it may be desire that a system with satellite access informs an authorized 3^{rd} party whether S&F operation is applied for communication with a UE and to provide information associated with the S&F operation. For example, the information provided to an authorized 3^{rd} party may include an estimated delivery time of MT messages to the UE.

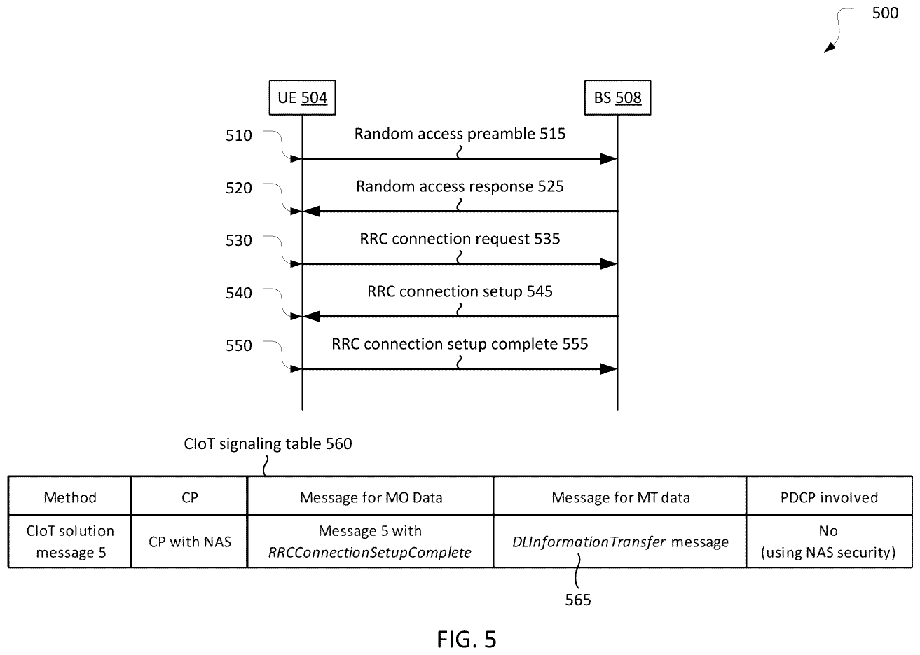

FIG. 5 illustrates a signaling diagram 500 in accordance with some embodiments. Signaling diagram 500 is an example of a cellular IoT (CIoT) procedure based on control plane signaling. The CIoT procedure may use control plane signaling and NAS security for carrying data.

In some instances, user data is transported via initial access signaling, such as control plane messages during the random access procedure.

At 510, the UE 504 may send a preamble to initiate an initial access procedure with the satellite BS 508. The preamble may be random access preamble 515. For example, the UE 504 may select the random access preamble 515 from a pool of available preambles and transmit the selected random access preamble on the physical random access channel (PRACH). The random access preamble 515 may be referred to as message 1 (MSG1).

At 520, the satellite BS 508 may send a response message to the UE 504 in response to the preamble it received from the UE 504. For example, the response message may be a random access response (RAR) 525. The RAR 525 may be generated by the MAC layer of the satellite BS 508 in response to the random access preamble 515. The RAR 525 may be transmitted on a physical downlink shared channel (PDSCH). The RAR 525 may be referred to as message 2 (MSG2).

At 530, the UE 504 may send a connection request message to the satellite BS 508. For example, the connection request message may be an RRC connection request 535. After receiving the RAR 525, the UE 504 may send the RRC connection request 535 to initiate the establishment of an RRC connection. The UE 504 may send the RRC connection request 535 on a physical uplink shared channel (PUSCH). The RRC connection request 535 may be referred to as message 3 (MSG3).

At 540, the satellite BS 508 may send a connection setup message to the UE 504. For example, the connection setup message may be an RRC connection setup 545. The RRC connection setup 545 may set up signaling radio bearer or other RRC parameters on the UE. The satellite BS 508 may send the RRC connection setup 545 on the PDSCH. The RRC connection setup 545 may be referred to as message 4 (MSG4).

At 550, the UE 504 may send a connection setup complete message to the satellite BS 508. For example, the connection setup complete message may be an RRC connection setup complete 555. The message may acknowledge receipt of the RRC connection setup 545 and be sent on PUSCH. Once the RRC connection setup complete 555 message is received by the satellite BS 508, and the RRC connection is established. The RRC connection setup complete 55 may be referred to as message 5 (MSG5).

In some embodiments, a UE, e.g., the UE 504, may initiate an initial access with a satellite BS, e.g., the satellite BS 508, while the satellite BS 508 is in S&F mode and does not have an active feeder link to a GS. The satellite BS 508 may inform the UE 504 of being in S&F mode via the random access response 525 (message 2) or the RRC connection setup 545 (message 4). In response to learning that the satellite BS 508 is in S&F mode, the UE 5087 may include its data in the RRC connection setup complete 555 (message 5).

In some embodiments, the satellite BS 508 may store mobile terminated (MT) messages for the UE 504. The satellite BS 508 may include the DL messages for the UE 504 in DL information transfer messages 565. In some instances, the DL information transfer message 565 may carry the RRC connection setup 545. In other instances, the DL information transfer message 565 may be used to transfer downlink control plane messages between the satellite BS 508 and the UE 504. The DL information transfer message 565 may be used to transfer NAS signaling. For example, the DL information transfer message 565 may be used to transfer RRC signaling messages, paging messages, system information, or broadcast messages.

Table 560 includes the CIoT signaling used for the transmission of data using the control plane messages during the initial access. For example, the MO data may be transmitted with message 5, e.g., RRC connection setup complete using the CIOT CP solution. The transmission does not involve packet data convergence protocol (PDCP) and may use NAS security.

Table 560 may also indicate that the MT data may be transmitted with a DL information transfer message, which may be a message 3 or some other DL control signaling. The transmission does not involve the PDCP layer and may use NAS security.

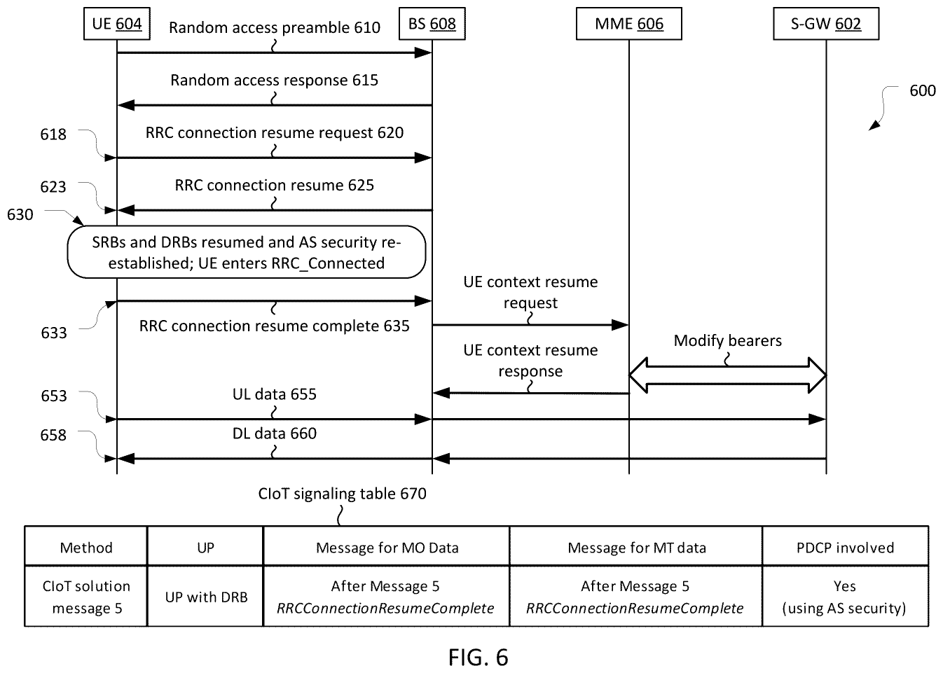

FIG. 6 illustrates a signaling diagram 600 in accordance with some embodiments. Signaling diagram 500 is an example of a cellular IoT (CIoT) procedure based on user plane signaling following an RRC connection resume signaling. The CIoT procedure may use user plane signaling and AS security for carrying data.

In some instances, user data is transported via a control plane entity, such as a mobility management (MME) entity.

Random access preamble 610 may be the same as random access preamble 515 in FIG. 5, as explained above.

Random access response 615 may be the same as random access response 525 in FIG. 5, as explained above.

At 618, the UE 604 may send a connection resume request message to the satellite BS 608. The connection resume request message may be an RRC connection resume request 620. The RRC connection resume request 620 may include a resume ID, a resume cause, or a short resume MAC-I field. The resume ID may be used by satellite BS 608 to identify the RRC connection that is to be resumed. The resume cause may indicate the reason why the RRC connection was suspended. The satellite BS 608 may use this information to determine how to resume the RRC connection. The short resume MAC-I may be used to protect the RRC connection resume request message from unauthorized access.

At 623, the satellite BS 608 may send a connection resume message to the UE 604. The connection resume message may be an RRC connection resume 625.

At 630, the signaling radio bearers (SRBs) and data radio bearers (DRBs) may be resumed, AS security may be re-established, and the UE 604 may enter RRC connected state.

At 633, the UE 604 may send a connection resume complete message to the satellite BS 608. The connection resume complete message may be an RRC connection resume complete 635. The RRC connection resume complete 635 may be referred to as message 5 (MSG 5).

If the satellite BS 608 were connected to the ground CN, it may perform a series signaling with an MME 606 or a serving gateway (S-GW) 602 to resume the UE context and apply any modifications needed to the radio bearers.

At 653, the UE 604 may send UL data 655 to the satellite BS 608. When satellite BS 608 is in S&F mode, the satellite BS 608 may store the UL data 655. The EU 608 may use user plane signaling on DRB for transmission of the MO UL data 655. The user plane signaling carrying the UL data 655 may be transmitted after the RRC connection resume complete 635 (message 5).

At 658, the BS 608 may send the DL data 660 to the UE 604. The satellite BS 608 may use user plane signaling on DRB for transmission of the MT DL data 660. The user plane signaling carrying the DL data 660 may be transmitted after the RRC connection resume complete 635 (message 5).

In some embodiments, a UE, e.g., an IoT UE, may send UL data to a satellite BS in S&F mode or receive data from a satellite BS in S&F mode using the signaling following an RRC resume procedure as described here.

Table 670 includes the CIoT signaling used for the transmission of data using the user plane messages during the initial access. For example, the MO data may be transmitted after message 5, e.g., RRC connection resume complete using the CIOT UP solution. The transmission may involve the PDCP layer and may use AS security.

Table 670 may also indicate that the MT data may be transmitted after the message, e.g., RRC connection resume complete message using the user plane with data radio bearer (DRB). The transmission may involve the PDCP layer and may use AS security.

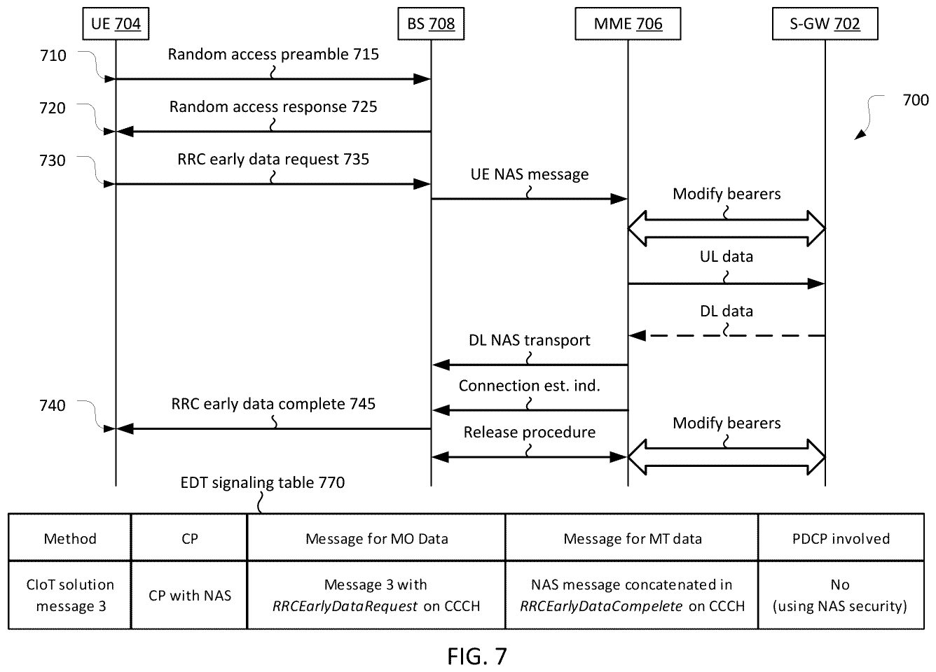

FIG. 7 illustrates a signaling diagram 700 in accordance with some embodiments. Signaling diagram 700 is an example of early data transmission (EDT) through control plane signaling. EDT may allow a UE to transmit data during the random access procedure before establishing the RRC connection. The EDT may use control plane signaling and NAS security for carrying data.

At 710, the UE 704 may send a preamble to initiate an initial access procedure with the satellite BS 708. The preamble may be random access preamble 715. The random access preamble 715 may be an example of the random access preamble 515 in FIG. 5.

At 720, the satellite BS 708 may send a response message to the UE 704 in response to the preamble it received from the UE 704. For example, the response message may be a random access response (RAR) 725. The RAR 725 may be an example of the RAR 525 in FIG. 5.

At 730, the UE 704 may send an early data request message to the satellite BS 708. For example, the early data request message may be an RRC early data request 735. The UE 704 may send the RRC early data request 735 to the satellite BS 708 to request permission to transmit data during the random access procedure and before establishing the RRC connection. The RRC early data request 735 may be transported on a common control channel (CCCH). The RRC early data request 535 may be referred to as message 3 (MSG3).

The RRC early data request 735 may include S-TMSI (serving temporary subscriber identity), establishment cause, or dedicated information NAS fields. The S-TMSI may be used to identify the UE 704. The satellite BS 708 may use the S-TMSI to identify the UE 704 and authorize early data transmission. Establishment cause may indicate the reason the UE is requesting to transmit early data. The satellite BS 708 may use this information to determine how to process the early data request. The dedicated information NAS field may be used to transmit

NAS signaling messages in the RRC early data request message. The dedicated information NAS field may allow the UE 704 to send NAS signaling messages to the core network without having to wait for the RRC connection to be established.

In some instances, the satellite BS 708 may process the RRC early data request message 735 and respond with a permission message, e.g., an RRC early data permission message. If the UE 708 is allowed to transmit data, it may send the data packet to the satellite BS 708 using the resources, e.g., time and frequency resources, that were specified in the RRC early data permission message.

In some instances, the UE 704 may include the data in the RRC early data request message 735 (in-band EDT).

In some instances, the satellite BS 708 is connected to the CN, e.g., MME 706 or S-GW 702. The satellite BS 708 may use additional CP or NAS signaling to send the UL data to the S-GW 702 through MME 706.

In some embodiments, the satellite BS 708 is in S&F mode. The satellite BS 708 may receive the UE's MO data sent in the RRC early data request 735 and store it until a feeder link is established.

At 745, the satellite BS 708 may send an early data complete message. The early data complete message may be an RRC early data complete 745. The RRC early data complete 745 may include a NAS message in the dedicated information NAS field. In some embodiment, the satellite BS 708 may send the UE's MT data to the UE 704 by concatenating the NAS message in RRC early data complete 745.

Table 770 includes the EDT signaling used for the transmission of data using the control plane messages during the initial access. For example, the MO data may be transmitted with message e, e.g., RRC early data request using the CIOT EDT CP solution. The transmission does not involve PDCP and may use NAS security.

Table 770 may also indicate that the MT data may be transmitted with the NAS message concatenated in the RRC early data complete message. The transmission does not involve the PDCP layer and may use NAS security.

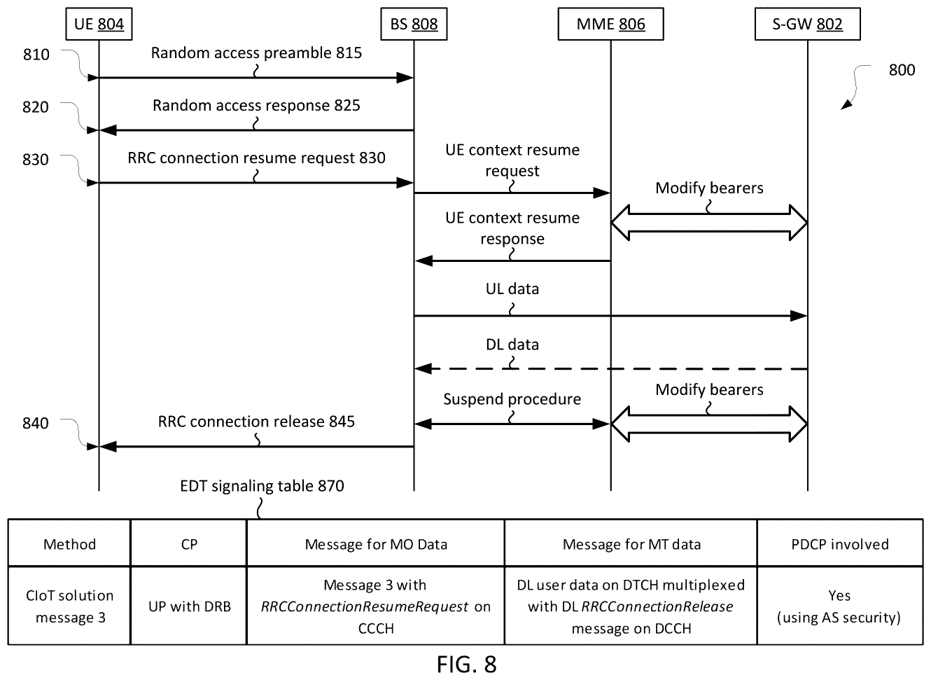

FIG. 8 illustrates a signaling diagram 800 in accordance with some embodiments. Signaling diagram 800 is an example of early data transmission (EDT) through user plane signaling. EDT may allow a UE to transmit data during the random access procedure before establishing the RRC connection. The EDT may use user plane signaling and AS security for carrying data.

At 810, the UE 804 may send a preamble to initiate an initial access procedure with the satellite BS 808. The preamble may be random access preamble 815. The random access preamble 815 may be an example of the random access preamble 515 in FIG. 5.

At 820, the satellite BS 808 may send a response message to the UE 804 in response to the preamble it received from the UE 804. For example, the response message may be a random access response (RAR) 825. The RAR 825 may be an example of the RAR 525 in FIG. 5.

At 830, the UE 804 may send a connection resume request message to the satellite BS 808. The connection resume request message may be an RRC connection resume request 830. The RRC connection resume request 830 may include a resume ID, a resume cause, or a short resume MAC-I field.

In some embodiments, the UE may send the MO data multiplexed with the RRC connection resume request 830 to the satellite BS 808 in S&F mode. The RRC connection resume request 830 multiplexed with the UE's MO data may be sent on a dedicated traffic channel (DTCH).

In some instances, the satellite BS 808 may be connected to the CN, e.g., MME 806 or S-GW 802. The satellite BS 808 may use additional CP or NAS signaling to send the UL data to the S-GW 802 through MME 806.

At 840, the satellite BS 808 may send a connection release message to the UE 804. The connection release message may be an RRC connection release 845. In some embodiment, the satellite BS 808 may multiplex the DL MT data to the RRC connection release 845. In some instances, the RRC connection release 845 may be transmitted on the dedicated control channel DCCH. In some instances, the DL MT data that is multiplexed with the RRC connection release 845 may be transmitted on DTCH.

Table 870 includes the EDT signaling used for the transmission of data using the user plane messages during the initial access and DRB. For example, the MO data may be transmitted with message 3, e.g., RRC connection resume request using the CIoT EDT UP solution. The transmission may involve PDCP and may use AS security.

Table 870 may also indicate that the MT data may be transmitted with DL user data on DTC multiplexed with the DL RRC connection release message on DCCH. The transmission may involve the PDCP layer and may use AS security.

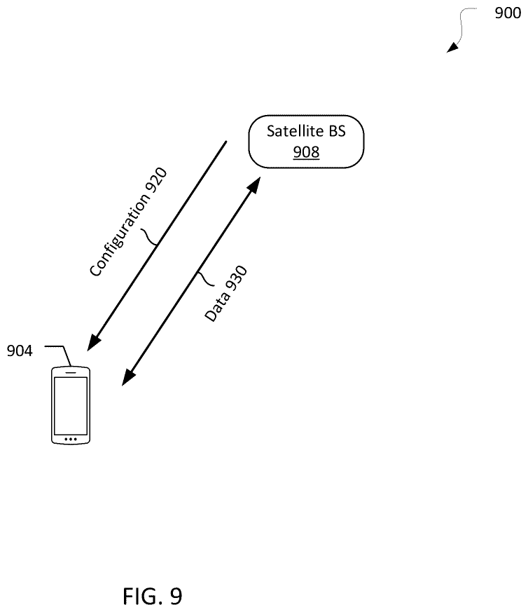

FIG. 9 illustrates a network environment 900 in accordance with some embodiments. Network environment 900 is an example of a satellite BS 908 operating in S&F mode. The Network environment 900 may include the satellite BS 908 coupled with a UE 904. The satellite BS 908 may operate in S&F mode, e.g., without an established feeder link to a ground station. The service link may carry configurations 920 or data 930. The satellite BS 908 may receive and store MO data from the UE 904. The satellite BS 908 may send the MT data to the UE 904.

In some instances, the UE 904 operation may be based at least partially on network operation mode. For example, the UE's decision whether to remain in an RRC connected state, initiate a network access procedure, monitor the paging channel, or the choice of data transmission may depend on whether the satellite BS 908 operates in a normal mode or an S&F mode.

In some instances, the network (NW), e.g., the satellite BS 908, may indicate its operation mode, e.g., normal mode or S&F mode, to the UE 904. The satellite BS 908 may use a dedicated S&F mode indication for signaling the operating mode to the UE 904. For example, the configuration 920 may include a field for the S&F mode indication. When the field has a logical value of ‘1’, it may indicate that the satellite BS 908 is operating in an S&F mode. A logical value of ‘0’ may indicate that the satellite BS 908 is operating normally.

In some instances, cell barring indication may be extended to indicate S&F mode. Cell barring indication in legacy systems may be a flag transmitted in a system information block (SIB), e.g., SIB 1. The cell barring indication may indicate whether or not the UE is barred from accessing the cell associated with the cell barring indication. For example, if the cell barring indication has a logical value of ‘1’, it may indicate that the UE's access to the cell associated with the cell barring indication is restricted.

The extended cell barring indication may include another extended flag associated with the S&F mode. The UE may use the barring flag or the extended flag to determine whether the access to the cell associated with the cell barring indication is restricted. The UE may use the barring flag or the extended flag to determine whether the satellite BS is in the S&F mode. For example, if the cell barring indication has a logical value of ‘1’ and the extended flag has a logical value of ‘0’, it may indicate to the legacy UEs or UEs without the capability of operating in S&F mode that they are barred from accessing the cell. However, it may indicate to the S&F mode capable UE that the cell is not barred and the satellite BS 908 is operating in the S&F mode.

In some instances, cell barring may bar services. For example, only data traffic associated with delay-tolerant services may be allowed when a cell barring indicates that the cell or satellite BS 908 switches to S&F mode.

In some instances, the S&F mode indicator may act as an unavailability time associated with a packet data network (PDN) connection. For example, a PDN connection having a PDU session or QoS flow with urgent timing requirements may be unavailable for transmission while the satellite BS 908 is in S&F mode. A timer may be associated with such PDN connections to indicate the unavailability of the PDN connection. The configuration 920 may include a timer associated with the unavailability timer of the PDN connections.

The configuration message 920 carrying the operation mode indication, e.g., normal mode or S&F mode, may be a SIB, a dedicated RRC signaling, a MAC control element (CE), a downlink control information (DCI), or a NAS layer signaling. The configuration message 920 may include a time point when the satellite BS 908 may re-establish a feeder link connection to a GS. The configuration 920 may include a starting time, an ending time, a duration, a duration, or a periodicity or repeating pattern associated with the S&F mode or normal mode. The configuration 920 may configure a timer in the UE 904 to enable the UE 904 to determine the time point at which the satellite BS 908 may switch from normal mode to S&F mode or from S&F mode to normal mode. In some instances, the operation mode indication may be per cell or per satellite. In some instances, the configuration 920 may include operation mode indication for neighbor cells or satellites.

In some instances, the GS, e.g., the AMF, may indicate to the satellite BS 908 timing information associated with S&F mode to the satellite BS 908. For example, the AMF may provide the time point at which the satellite BS 908 may switch from a normal mode to an

S&F mode. The AMF may also provide information associated with the duration of the S&F mode or the normal mode, periodicity of the S&F mode or the normal mode, a start time of the S&F mode or normal mode, or a stop time of the S&F mode or normal mode.

In some instances, the UE 904 is an IoT UE. Some or all of the services associated with an IoT UE may be delay-tolerant services. Upon switching the satellite BS 908 from normal to S&F mode, the IoT UE 904 may switch to an RRC idle or inactive state or remain in the RRC connected state.

The configuration 920 may contain information such as the total data amount allowed for transmission when the satellite BS 908 is in S&F mode or the frequency of transmission, e.g., how often the IoT UE 904 may send data to the satellite BS 908. The configuration 920 may include information associated with allowed PDN connections, e.g., allowed PDU sessions, QoS class identifiers (QCIs), QoS flow identifiers (QFIs), or 5G QoS identifiers (5QIs). For example, the configuration 920 may include CIoT configuration, including assigning PDN connections for CIoT transmission during the S&F mode. The configuration 920 may indicate whether UE is allowed to initiate delay-sensitive services.

The UE 904 may filter its services or applications based on the configuration 920. The UE 904 may transmit delay-tolerant packets when the satellite BS 908 is in S&F mode.

The configuration 920 may configure cell selection or cell reselection parameters. For example, the configuration 920 may prioritize a cell or satellite BS operating in a normal mode and deprioritize a cell or satellite in an S&F mode. For example, configuration 920 may include an offset for reference signal received power (RSRP) or reference signal received quality (RSRQ) to be added to RSRP or RSRQ associated with a cell or satellite in normal mode.

The UE 904 may determine that the satellite BS 908 switches from S&F mode to normal mode from an indication or a timer. In one example, the satellite may send an indication to the UE 904, e.g., via configuration 920, associated with switching from S&F mode to normal mode. In another example, the UE 904 may be configured with a timer that can indicate the time point at which the satellite BS 908 switches from the S&F mode to normal mode.

In one embodiment, the configuration 920 may include two sets of configurations, one for UE operation when the satellite 908 is in S&F mode and one for UE operation when the satellite 908 is in normal mode. Each set of configurations may include NAS and AS layer configurations.

In the set of configurations associated with S&F mode, delay-tolerant services, e.g., PDN connections, QCI flows, PDU sessions, 5QI flows) may be configured with high priority, e.g., a priority higher than the priority of delay-sensitive services. Delay-sensitive services may be configured with low priority, e.g., priority lower than the delay-tolerant services.

In the set of configurations associated with normal mode, delay-tolerant services, e.g., PDN connections, QCI flows, PDU sessions, 5QI flows) may be configured with low priority, e.g., a priority lower than the priority of delay-sensitive services. Delay-sensitive services may be configured with high priority, e.g., priority higher than the delay-tolerant services.

Each set of configurations may have values for parameters such as logical channel (LCH) priority, packet delay budget (PDB), or the maximum bit rate (MBR).

When the satellite BS 908 switches to S&F mode, the UE 904 may apply the set of configurations for S&F mode. When the satellite BS 908 switches to normal mode, the UE 904 may apply the set of configurations for normal mode.

In some embodiments, the configuration 920 may include a QCI or 5QI associated with traffic flow for S&F mode. The QCI or 5QI associated with the S&F mode may include a prolonged packet data budget (PDB).

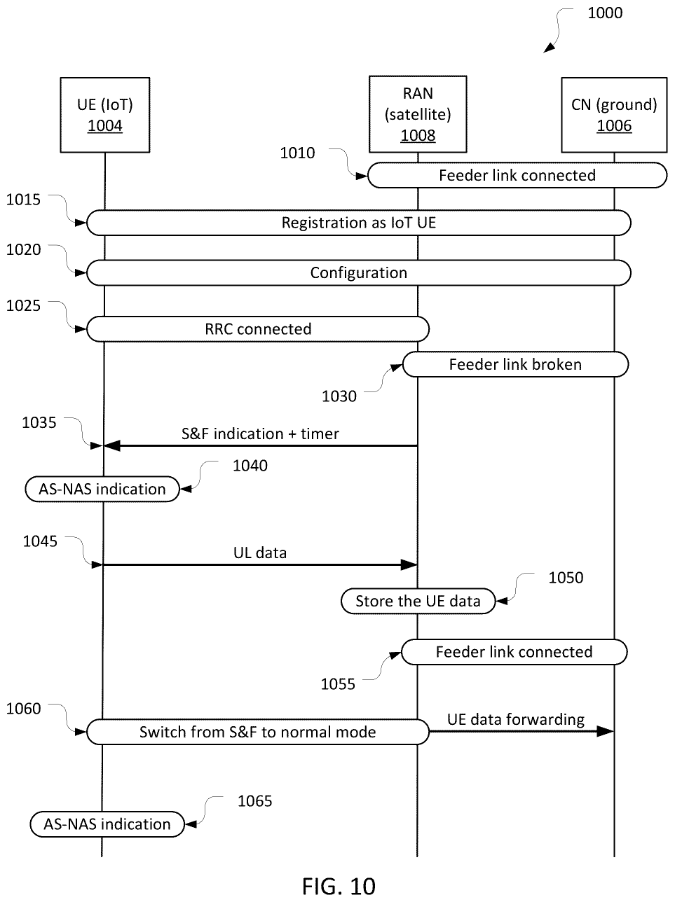

FIG. 10 illustrates a signaling diagram 1000 in accordance with some embodiments. Signaling diagram 1000 is an example of data transmission during S&F mode.

At 1010, a feeder link is active and connected between the satellite BS 1008, e.g., the RAN, and the GS 1006, e.g., the CN.

At 1015, the IoT UE 1004 may register with the GS 1006 as an IoT UE. The IoT UE 1004 may indicate supporting satellite S&F mode.

At 1020, the IoT UE 1004 may receive configurations from the satellite BS 1008 or the GS 1006. The received configurations may be examples of configuration 920 in FIG. 9. The received configuration may include an S&F mode policy or a list of PDN connections, QCIs, or 5Qis allowed for transmission when satellite BS 1008 is in S&F mode.

At 1025, the IoT UE 1004 is in an RRC connected state with the satellite BS 1008, and the satellite BS 1008 is in normal mode.

At 1030, the feeder link breaks, and the satellite BS 1008 switches its operation from normal mode to S&F mode.

At 1035, the satellite BS 1008 may send an S&F indication to the IoT UE 1004. In association with switching the operation mode to S&F, the satellite BS may determine and select one of the following options.

In option one, the satellite may release the RRC connection to the UE. For example, the satellite BS 1008 may send an RRC connection release message. The RRC connection message may include or be multiplexed with additional information, such as a cause value for S&F mode or a timer.

At 1040, the IoT UE's AS may indicate to the NAS that the satellite BS 1008 is operating in S&F mode.

At 1045, the UE may transmit allowed data, e.g., data traffic associated with the list of allowed PDN connections or QCIs, with RRC message using EDT or CIOT schemes with control plane or user plane solutions described in FIGS. 5-8.

In option two, the satellite may only send a timer along with the S&F mode indication. The IoT UE 1004 may remain in the RRC connected state.

At 1040, the IoT UE's AS may indicate to the NAS that the satellite BS 1008 is operating in S&F mode.

At 1045, the IoT UE 1004 in the RRC connected state may use normal UL transmissions to send allowed data to the satellite BS 10008.

Regardless of whether the satellite BS 1008 follows option one or option two above, the satellite BS 1008 may switch from S&F mode to normal mode. The satellite BS 1008 may indicate switching to normal mode to the IoT UE 1004. For example, the satellite BS 1008 may include in SIB or a dedicated signaling an indication of switching from S&F mode to normal mode. The IoT UE 1004 may determine the switching point by the configured timer at 1035.

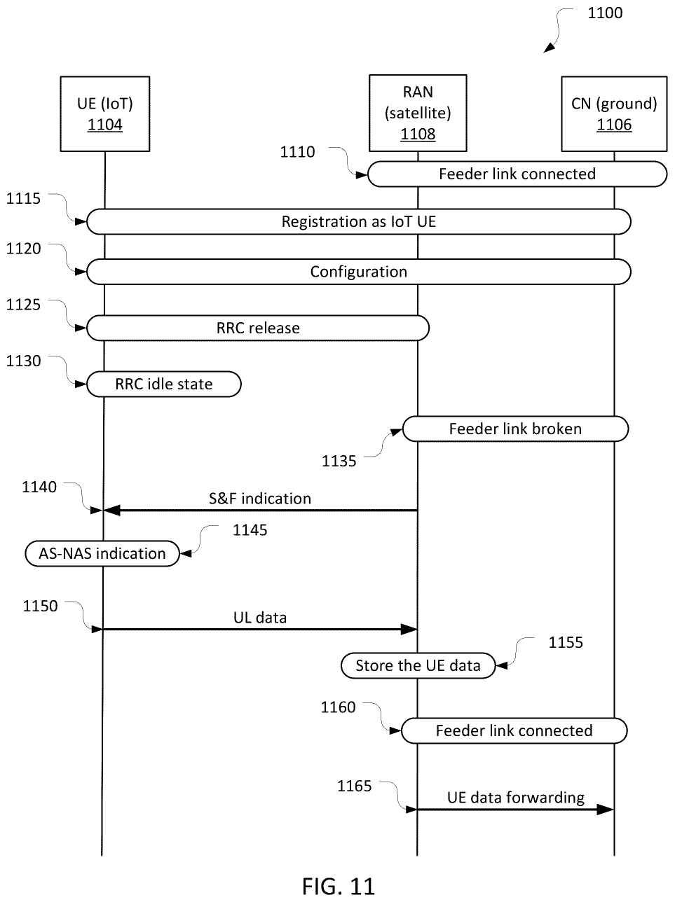

FIG. 11 illustrates a signaling diagram 1100 in accordance with some embodiments. Signaling diagram 1100 is an example of data transmission during S&F mode.

At 1110, a feeder link is active and connected between the satellite BS 1108, e.g., the RAN, and the GS 1106, e.g., the CN.

At 1115, the IoT UE 1104 may register with the GS 1106 as an IoT UE. The IoT UE 1104 may indicate supporting satellite S&F mode.

At 1120, the IoT UE 1104 may receive configurations from the satellite BS 1108 or the GS 1106. The received configurations may be examples of configuration 920 in FIG. 9. The received configuration may include an S&F mode policy or a list of PDN connections, QCIs, or 5Qis allowed for transmission when satellite BS 1108 is in S&F mode. The IoT UE 1104 is in an RRC connected state with the satellite BS 1108, and the satellite BS 1108 is in normal mode. The configurations may configure the IoT UE 1104 with CIOT or EDT solutions described in FIGS. 5-8.

At 1125, the satellite 1108 may release the RRC connection with the IoT UE 1104. For example, the satellite 1108 may release the RRC connection with the IoT UE 1104 by sending an RRC release message to the IoT UE 1104.

At 1130, the IoT UE 1104 may be in an RRC idle or inactive state.

At 1135, the feeder link breaks, and the satellite BS 1108 switches its operation from normal mode to S&F mode.

At 1140, the satellite BS 1108 may send an S&F indication to the IoT UE 1104.

At 1145, the IoT UE's AS may indicate to the NAS that the satellite BS 1108 is operating in S&F mode.

At 1150, the IoT UE 1104 may transmit allowed data, e.g., data traffic associated with the list of allowed PDN connections or QCIs, with RRC message using EDT or CIoT schemes with control plane or user plane solutions described in FIGS. 5-8.

At 1155, the satellite BS 1108 may store the UE's received allowed data.

At 1160, the feeder link may be re-established, connecting the satellite BS 1108 to the GS 1106.

At 1165, the satellite 1108 may forward UE's stored data to the GS 1106.

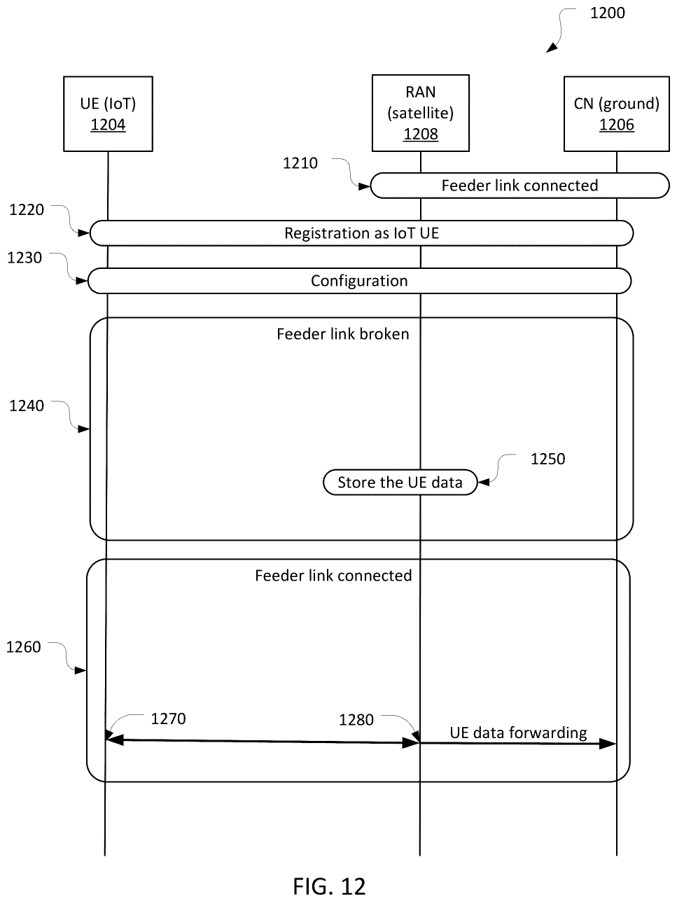

FIG. 12 illustrates a signaling 1200 diagram in accordance with some embodiments. Signaling diagram 1200 is an example of data transmission during S&F mode.

At 1210, a feeder link is active and connected between the satellite BS 1208, e.g., the RAN, and the GS 1206, e.g., the CN.

At 1220, the IoT UE 1104 may register with the GS 1106 as an IoT UE. The IoT UE 1104 may indicate supporting satellite S&F mode.

At 1230, the IoT UE 1204 may receive configurations from the satellite BS 1208 or the GS 1206. The received configurations may be examples of configuration 920 in FIG. 9. The received configuration may include an S&F mode policy or a list of PDN connections, QCIs, or 5Qis allowed for transmission when satellite BS 1208 is in S&F mode. The configuration may include an unavailability period. The unavailability time may indicate the period during which the feeder link is unavailable. The CN, e.g., the AMF may provide the unavailability period to the IoT UE 1204. The unavailability period may be provided to the IoT UE 1204 through NAS signaling.

The IoT UE 1204 is in an RRC connected state with the satellite BS 1208, and the satellite BS 1208 is in normal mode. The configurations may configure the IoT UE 1204 with CIOT or EDT solutions described in FIGS. 5-8.

At 1240, the feeder link is broken, and the satellite 1208 may switch to the S&F mode, and the unavailability timer is triggered. During unavailability, the IoT UE 1204 may initiate data transmission for the allowed PDN connections, PDU sessions, QCIs, or 5QIs. The IoT UE 1204 may use CIOT, EDT, or both to send allowed data to the satellite BS 1208.

In some instances, the NAS may indicate to the AS about the unavailability period. The IoT UE 1204 may log the information of the unavailability period for the satellite BS 1208. The IoT UE 1204 may perform radio resource management (RRM) relaxation on the satellite BS 1208 during unavailability.

At 1250, the satellite BS 1208 may store the UE's received allowed data.

At 1260, the unavailability period may expire, and the feeder link may be re-established, connecting the satellite BS 1208 to the GS 1206.

At 1270, the IoT UE 1204 may resume normal operation in both NAS and AS.

At 1280, the satellite BS 1208 may forward the UE's stored data to the GS 1206.

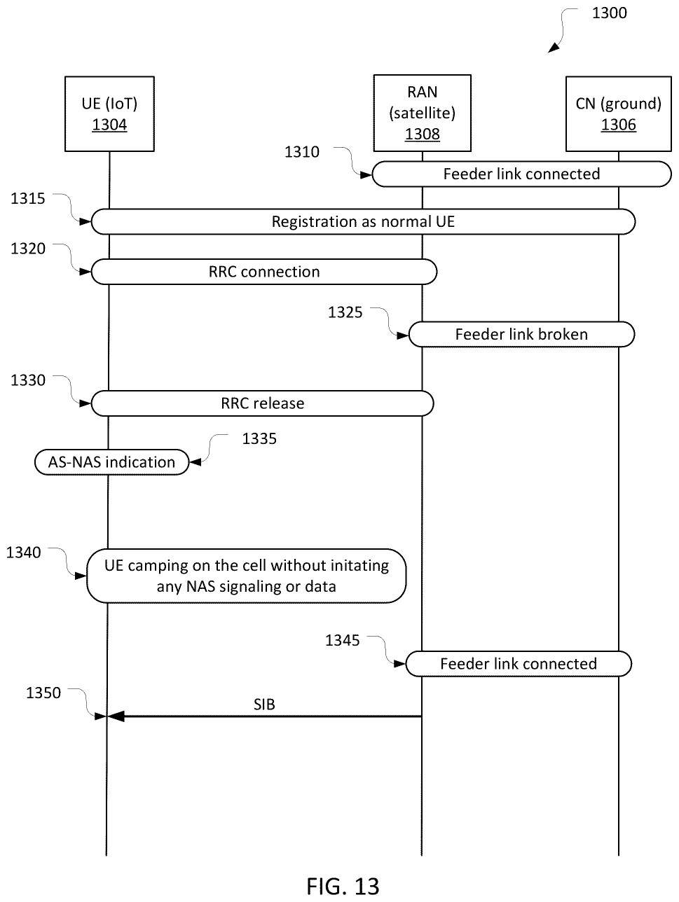

FIG. 13 illustrates a signaling diagram 1300 in accordance with some embodiments. Signaling diagram 1300 is an example of data transmission during S&F mode in which the UE 1304 is a normal UE. A normal UE is referred herein to a UE that may receive and correctly interpret an indication associated with S&F mode. However, the UE does not have data, is not allowed for data transmission, or is not capable of data transmission during the S&F mode.

At 1310, a feeder link is active and connected between the satellite BS 1308, e.g., the RAN, and the GS 1306, e.g., the CN.

At 1315, the normal UE 1304 may register with the GS 1306 as a normal UE. The normal UE 1304 may indicate that the normal UE 1304 may not support data transmission during satellite S&F mode.

At 1320, the normal UE 1304 is in an RRC connected state with the satellite BS 1308, and the satellite BS 1308 is in normal mode.

At 1325, the feeder link is broken, and the satellite 1308 may switch to the S&F mode.

At 1330, the satellite 1308 may release the RRC connection with the normal UE 1304. For example, the satellite 1308 may release the RRC connection with the normal UE 1304 by sending an RRC release message to the normal UE 1304. The RRC release message may include an S&F indication or a timer.

At 1335, the normal UE's AS may indicate to the NAS that the satellite BS 1308 is operating in S&F mode.

At 1340, the normal UE 1304 may camp on the cell without initiating any NAS signaling or data transmission.

At 1345, the feeder link may be re-established, connecting the satellite BS 1308 to the GS 1306.

At 1350, the satellite BS 1308 may indicate switching from normal mode to the normal UE 1304. For example, the satellite BS 1308 may include in SIB or a dedicated signaling an indication of switching from S&F mode to normal mode. The normal UE 1304 may determine the switching point by the configured timer at 1330.

Normal UE 1304 in RRC idle or inactive state, while satellite BS 1308 is in S&F mode, may relax the RRM requirements for serving satellite BS 1308 in S&F mode. For example, the normal UE 1304 may modify the measurement requirements for RRM, which may reduce power consumption at the UE. Normal UE 1304 may also deprioritize cells served by a satellite in S&F mode.

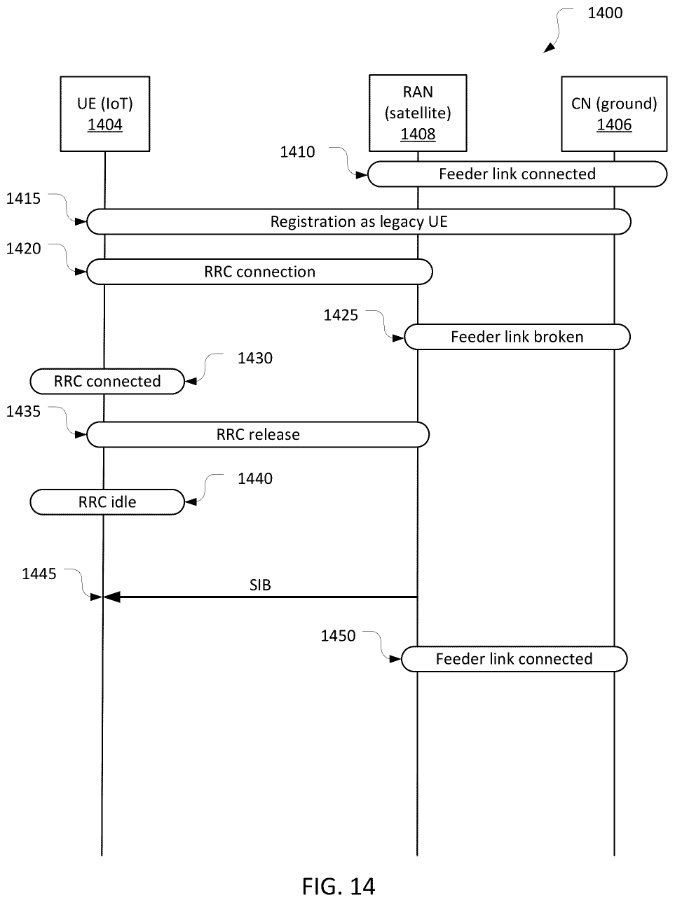

FIG. 14 illustrates a signaling diagram 1400 in accordance with some embodiments. Signaling diagram 1400 is an example of data transmission during S&F mode in which the UE 1404 is a legacy UE. The legacy UE may not be able to receive or interpret an indication associated with S&F mode.

At 1410, a feeder link is active and connected between the satellite BS 1408, e.g., the RAN, and the GS 1406, e.g., the CN.

At 1415, the legacy UE 1404 may register with the GS 1406 as a legacy UE.

At 1420, the legacy UE 1404 is in an RRC connected state with the satellite BS 1408, and the satellite BS 1408 is in normal mode.

At 1425, the feeder link is broken, and the satellite 1408 may switch to the S&F mode.

At 1430, the legacy UE 1404 may be in an RRC connected state with the satellite BS 1408, and the satellite BS 1408 is in S&F mode.

At 1435, the satellite 1408 may release the RRC connection with the legacy UE 1404. For example, the satellite 1408 may release the RRC connection with the legacy UE 1404 by sending an RRC release message to the legacy UE 1404. The RRC release message may include a timer. The legacy UE 1404 may transition to an RRC idle state. The satellite BS 1408 may use cell barring indication, legacy flag alone, or legacy flag with the extended S&F cell barring flag to let the legacy UE 1404 bar the cell in S&F mode.

At 1445, the satellite BS 1408 may reconnect with the legacy UE 1404 when switching to normal mode. For example, the satellite BS 1408 may include in SIB or a dedicated signaling to reconnect with the legacy UE 1404. For example, the satellite BS 1408 may use the call barring field in SIB to reconnect the legacy UE 1404.

At 1450, the feeder link may be re-established, connecting the satellite BS 1408 to the GS 1406.

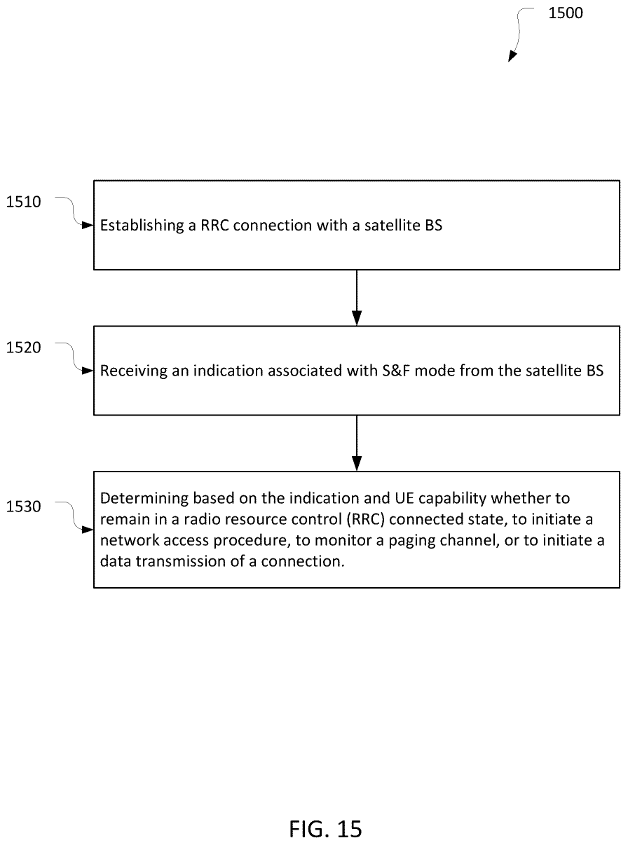

FIG. 15 illustrates an operational flow/algorithmic structure in accordance with some embodiments. The operation flow/algorithmic structure 1500 may be implemented by a UE (for example, UE 104 or UE 1700) or components therein, for example, processing circuitry 1704.

The operation flow/algorithmic structure 1500 may include, at 1510, establishing an RRC connection with a satellite BS. The establishing an RRC connection with the satellite BS may include sending a registration request to a core network, e.g., a GS. The registration request may include capability information associated with the UE supporting the satellite S&F mode.

The UE may receive a registration response in response to the registration request. The registration response may include configurations associated with the S&F mode. Transition based on the registration response to the RRC connected state.

The operation flow/algorithmic structure 1500 may include, at 1520, receiving, from a satellite BS, an indication associated with an S&F mode of the satellite BS. The indication may indicate that the satellite BS is in S&F mode. Based on the indication, the UE may prioritize a cell in normal mode over a cell in S&F mode. For example, the UE may increase the priority associated with a cell in normal mode. The increased priority of the cell in normal mode may be higher than the priority of a cell in S&F mode. Based on the received indication, the UE may deprioritize a cell in S&F mode.

The operation flow/algorithmic structure 1500 may include, at 1530, determining, based on the indication and UE capability, whether to remain in a radio resource control (RRC) connected state, to initiate a network access procedure, monitor a paging channel, or to initiate a data transmission of a connection.

The determination may include receiving RRC messages from the satellite BS. For example, the UE may receive an RRC connection release message and release the RRC connection based on the received message. The UE may transition to the RRC disconnected state, RRC idle state, or RRC inactive state. The UE may transmit allowed data to the satellite in or with an RRC message.

Alternatively, the UE may remain in an RRC connected state and select an allowed connection, e.g., a PDN connection, a QCI, a 5QI, or a PDU session, and transmit the data of the connection to the satellite BS.

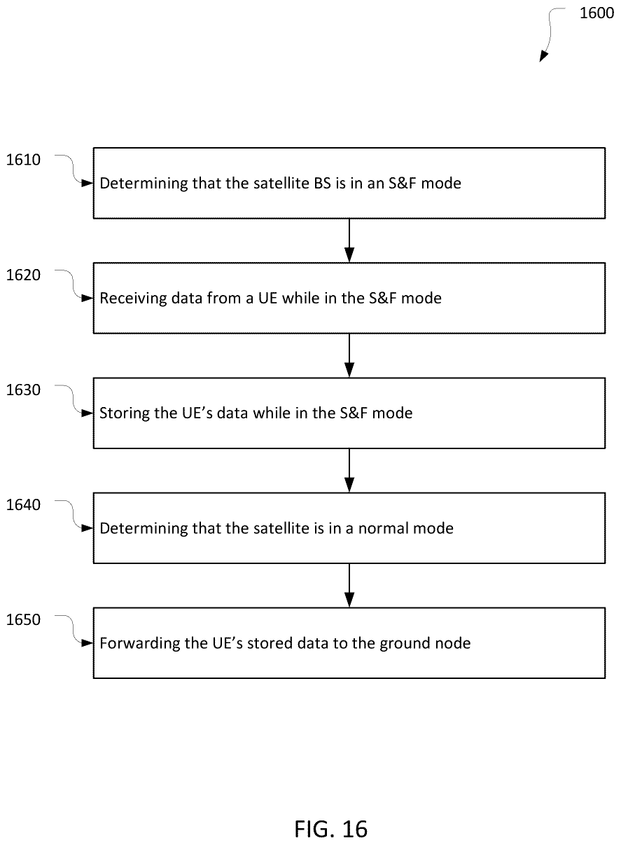

FIG. 16 illustrates an operational flow/algorithmic structure in accordance with some embodiments. The operational flow/algorithmic structure 1600 may be implemented by a network node, for example, the satellite BS 108, the network node 1800, or components therein, e.g., processors 1804.

The operational flow/algorithmic structure 1600 may include, at 1610, determining that the satellite BS is in an S&F mode. The satellite BS may monitor the feeder link and determine whether the feeder link is active.

The operational flow/algorithmic structure 1600 may include, at 1620, receiving data from a UE while the satellite BS is in the S&F mode. The satellite BS may receive the data through CIOT or EPT schemes.

The operational flow/algorithmic structure 1600 may include, at 1630, storing the UE's data while the satellite BS is in S&F mode. The satellite BS may be configured with a quota for storage. The quota may be per satellite or per UE.

The operational flow/algorithmic structure 1600 may include, at 1640, determining that the satellite BS is in normal mode. By monitoring the feeder link, the satellite BS may determine whether it is in S&F mode or normal mode or whether the BS has to switch from one mode to the other.

The operational flow/algorithmic structure 1600 may include, at 1650, forwarding the UE's stored data to the ground node.

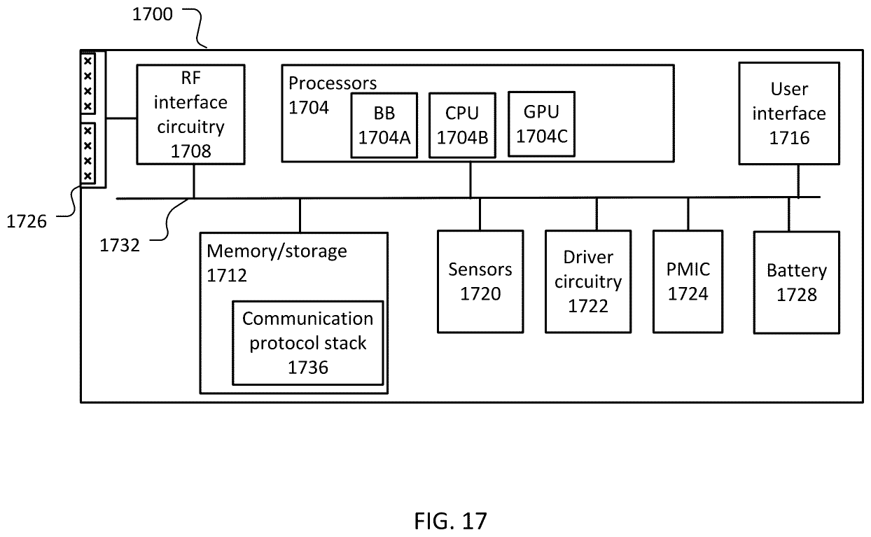

FIG. 17 illustrates a UE 1700 in accordance with some embodiments. The UE 1700 may be similar to and substantially interchangeable with devices 104 of FIG. 1.

The UE 1700 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1700 may include processors 1704, RF interface circuitry 1708, memory/storage 1712, user interface 1716, sensors 1720, driver circuitry 1722, power management integrated circuit (PMIC) 1724, antenna structure 1726, and battery 1728. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangements of the components shown may occur in other implementations.

The components of the UE 1700 may be coupled with various other components over one or more interconnects 1732, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry, or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP-compatible network. In general, the baseband processor circuitry 1704A may access the communication protocol stack 1736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1712 may include one or more non-transitory, computer-readable media that includes instructions (for example, the communication protocol stack 1736) that may be executed by one or more of the processors 1704 to cause the UE 1700 to perform various operations described herein. The memory/storage 1712 includes any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1708 may include transceiver circuitry and a radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1726 and proceed to filter and amplify (with a low-noise amplifier) the signal. The signal may be provided to a receiver of the transceiver that down-converts the RF signal into a baseband signal that is provided to the baseband processor of the processor 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1726.

In various embodiments, the RF interface circuitry 1708 may be configured to transmit/receive signals in a manner compatible with NR access technologies.

The antenna 1726 may include antenna elements to convert electrical signals into radio waves to travel through the air and to convert received radio waves into electrical signals. The antenna elements may be arranged into one or more antenna panels. The antenna 1726 may have antenna panels that are omnidirectional, directional, or a combination thereof to enable beamforming and multiple input, multiple output communications. The antenna 1726 may include microstrip antennas, printed antennas fabricated on the surface of one or more printed circuit boards, patch antennas, or phased array antennas. The antenna 1726 may have one or more panels designed for specific frequency bands, including bands in FR1 or FR2.

The user interface circuitry 1716 includes various input/output (I/O) devices designed to enable user interaction with the UE 1700. The user interface 1716 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various I/O devices that may be present within or connected to the UE 1700. For example, the driver circuitry 1722 may include circuitry to facilitate the coupling of a universal integrated circuit card (UICC) or a universal subscriber identity module (USIM) to the UE 1700. For additional examples, driver circuitry 1722 may include a display driver to control and allow access to a display device, a touchscreen driver to control and allow access to a touchscreen interface, sensor drivers to obtain sensor readings of sensor circuitry 1720 and control and allow access to sensor circuitry 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage the power provided to various components of the UE 1700. In particular, with respect to the processors 1704, the PMIC 1724 may control power-source selection, voltage scaling, battery charging, or DC-to-DC conversion.

In some embodiments, the PMIC 1724 may control or otherwise be part of various power-saving mechanisms of the UE 1700, including DRX, as discussed herein.

A battery 1728 may power the UE 1700, although in some examples, the UE 1700 may be mounted and deployed in a fixed location and may have a power supply coupled to an electrical grid. The battery 1728 may be a lithium-ion battery, a metal-air battery, such as a zinc-air battery, an aluminum-air battery, a lithium-air battery, and the like. In some implementations, such as in vehicle-based applications, the battery 1728 may be a typical lead-acid automotive battery.

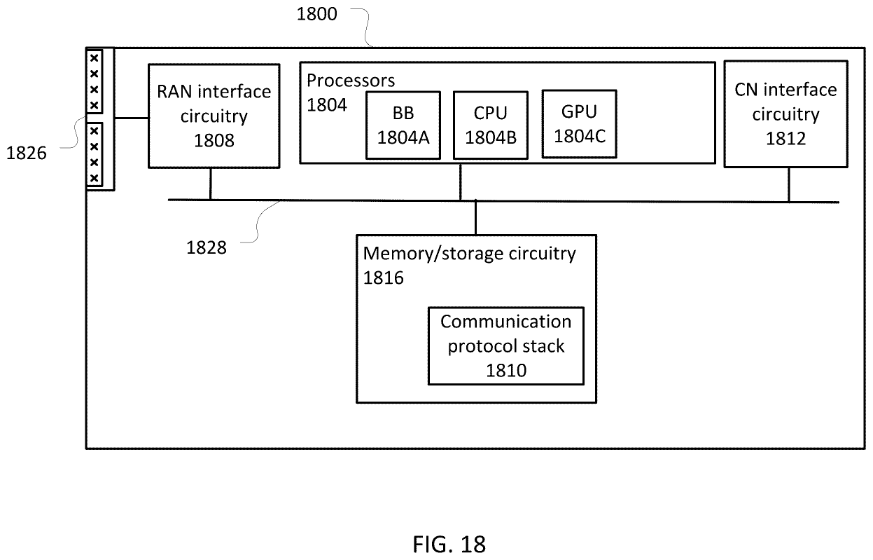

FIG. 18 illustrates a network node 1800 in accordance with some embodiments. The network node 1800 may be similar to and substantially interchangeable with AP 108, a device implementing one of the network hops, an integrated access and backhaul (IAB) node, a network-controlled repeater, or a server in a core network or external data network.

The network node 1800 may include processors 1804, RF interface circuitry 1808 (if implemented as an access node), the core node (CN) interface circuitry 1812, memory/storage circuitry 1816, and antenna structure 1826.

The components of the network node 1800 may be coupled with various other components over one or more interconnects 1828.

The processors 1804, RF interface circuitry 1808, memory/storage circuitry 1816 (including communication protocol stack 1810), antenna structure 1826, and interconnects 1828 may be similar to like-named elements shown and described with respect to FIG. 17.

The processors 1804 may perform operations associated with establishing sub-THz link with a device consistent with embodiments described herein.

The CN interface circuitry 1812 may provide connectivity to a core network, for example, a 5th Generation Core network (5GC) using a 5GC-compatible network interface protocol such as carrier Ethernet protocols or some other suitable protocol. Network connectivity may be provided to/from the network node 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

In some embodiments, the network node 1800 may be coupled with transmit-receive points (TRPs) using the antenna structure 1826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

Example 1 includes a method implemented by a user equipment (UE), the method including: establishing a radio resource control (RRC) connection with a satellite base station (BS); receiving, from the satellite BS, an indication associated with a store and forward (S&F) mode of the satellite BS; and determining, based on the indication and a UE capability, whether to remain in a radio resource control (RRC) connected state, to initiate a network access procedure, to monitor a paging channel, or to initiate a data transmission of a connection.

Example 2 includes the method of claim 1 or some other examples herein, wherein the indication is included in a system information block (SIB), an RRC signaling, a medium access control (MAC) control element (CE), a DCI, or a non-access stratum (NAS) signaling.

Example 3 includes the method of claim 1 or 2 or some other examples herein, wherein the indication is included in a cell barring indication having a first flag and a second flag; the method further comprises: determining, based on the first flag or the second flag, whether an access to a cell is restricted; and determining, based on the first flag or the second flag, whether the satellite BS operates in the S&F mode.

Example 4 includes the method of claims 1-3 or some other examples herein, wherein the indication includes a timer configuration having an S&F starting time, an S&F duration, or an S&F periodicity.

Example 5 includes the method of any of claims 1-4 or some other examples herein, wherein the connection is a packet data network (PDN) connection, a protocol data unit (PDU) session, a quality of service (QOS) flow, or a service data flow (SDF).

Example 6 includes the method of any of claims 1-5 or some other examples herein, wherein: the UE capability supports the S&F mode; said determining, based on the indication and the UE capability, whether to remain in the radio resource control (RRC) connected state, to initiate the network access procedure, to monitor the paging channel, or to initiate the data transmission of the connection includes determining to initiate the data transmission of the connection; and the method further includes: restricting the connection to include a delay-tolerant connection.

Example 7 includes the method of any of claims 1-6 or some other examples herein, wherein said determining, based on the indication and the UE capability, whether to remain in the radio resource control (RRC) connected state, to initiate the network access procedure, to monitor the paging channel, or to initiate the data transmission of the connection includes determining to initiate the data transmission of the connection; and the method further includes: selecting the connection based on the indication; and assigning a quality of service identifier associated with the S&F mode to the connection.

Example 8 includes the method of any of claims 1-7 or some other examples herein, wherein said establishing the RRC connection with the satellite BS includes: sending, to a core network (CN), a registration request having capability information associated with the IoT UE supporting the satellite S&F mode; receiving, from the CN, a registration response including configurations associated with the S&F mode; and transitioning, based on the registration response, to the RRC connected state.

Example 9 includes the method of any of claims 1-8 or some other examples herein, wherein the UE is an internet of things (IoT) UE, and the method further includes: determining, based on the indication, that the satellite BS is in the S&F mode.

Example 10 includes the method of any of claims 1-9 or some other examples herein, further including: prioritizing a first cell in a normal mode, or deprioritizing a second cell in S&F mode.

Example 11 includes the method of any of claims 1-10 or some other examples herein, wherein the configurations include one or more indications associated with an S&F mode policy, a packet data network (PDN) connection, a quality of service (QOS) class identifier (QCI), a QoS flow identifier (QFI), a QoS identifier (5QI), or an S&F timer configuration including a start time, a stop time, a duration, or a periodicity.

Example 12 includes the method of any of claims 1-11 or some other examples herein, wherein said determining, based on the indication and the UE capability, whether to remain in the radio resource control (RRC) connected state, to initiate the network access procedure, to monitor the paging channel, or to initiate the data transmission for the connection includes determining not to remain in the RRC connected state; to initiate the network access procedure or to monitor the paging channel; and to initiate the data transmission the connection, the method further includes: receiving, from the satellite BS, an RRC connection release message; releasing the RRC connection to the satellite BS based on the RRC release message; transitioning, based on the RRC release message, to an RRC disconnected state, an RRC idle state, or an RRC inactive state; and transmitting, to the satellite BS in the S&F mode, an RRC message including the data of the connection.

Example 13 includes the method of any of claims 1-12 or some other examples herein, wherein the RRC message is: an RRC connection setup complete message; an RRC connection resume complete message; or a downlink (DL) information transfer message.

Example 14 includes the method of any of claims 1-13 or some other examples herein, further including: receiving, from the satellite BS, a switching message indicating that the satellite BS switching operation from the S&F mode to a normal mode.

Example 15 includes the method of any of claims 1-14 or some other examples herein, wherein the switching message is included in a system information block (SIB) or in a dedicated signaling.

Example 16 includes the method of any of claims 1-15 or some other examples herein, wherein: said determining, based on the indication and the UE capability, whether to remain in the radio resource control (RRC) connected state, to initiate the network access procedure, to monitor the paging channel, or to initiate the data transmission for the connection includes determining to remain in the RRC connected state and to initiate the data transmission of the connection, the method further includes: remaining in the RRC connected state; selecting the connection based on the configurations; and transmitting, to the satellite BS, the data of the connection.

Example 17 includes the method of any of claims 1-16 or some other examples herein, the method further including: receiving, from the satellite BS, a timer configuration associated with a timer; and determining, based on the timer, a switching time associated with a switching of an operation of the IoT UE from the S&F mode to a normal mode.

Example 18 includes the method of any of claims 1-17 or some other examples herein, wherein said establishing the RRC connection with the satellite BS further including: receiving, from the satellite BS, an RRC release message; and transitioning, based on the RRC release message, to an RRC idle state or an RRC inactive state.

Example 19 includes the method of any of claims 1-18 or some other examples herein, wherein: said determining, based on the indication and the UE capability, whether to remain in the radio resource control (RRC) connected state, to initiate the network access procedure, to monitor the paging channel, or to initiate the data transmission for the connection includes initiate the data transmission of the connection, the method further includes: determining, based on the indication, that the satellite BS is in the S&F mode; selecting the connection based on the configurations; and transmitting, to the satellite BS in the S&F mode, an RRC message including the data of the connection.

Example 20 includes the method of any of claims 1-19 or some other examples herein, wherein the UE is an internet of thing (IoT) UE, said determining, based on the indication and the UE capability, whether to remain in the radio resource control (RRC) connected state, to initiate the network access procedure, to monitor the paging channel, or to initiate the data transmission of the connection includes determining to initiate the data transmission of the connection, the method further includes: selecting the connection based on the configurations; determining an unavailability period based on the configurations; transmitting, to the satellite BS during the unavailability period, an RRC message including the data of the connection; and determining, based on the configurations, a switching time associated with a switching an operation of the IoT UE from the S&F mode to a normal mode.

Example 21 includes the method of any of claims 1-20 or some other examples herein, the method further including: selecting, based on the indication and the configurations, an operating configuration; and configuring the IoT UE based on the operating configuration.

Example 22 includes the method of any of claims 1-21 or some other examples herein, wherein the configurations include a S&F configuration and a normal configuration, and said selecting, based on the indication, the operating configuration includes: selecting the S&F configuration based on the indication being associated with the S&F mode, or selecting the normal configuration based on the indication being associated with a normal mode.

Example 23 includes a method implemented by a satellite base station (BS), the method including: determining, by the satellite BS, that the satellite BS is in a store and forward (S&F) mode; receiving, by the satellite BS in the S&F mode, data from a user equipment (UE); storing, by the satellite BS in the S&F mode, the data; determining, by the satellite BS, that the satellite BS is in a normal mode; and forwarding, by the satellite BS in the normal mode, the stored data to a ground node.

Example 24 includes the method of example 23 or some other examples herein, wherein said determining, by the satellite BS, that the satellite BS is in the S&F mode includes: determining that a feeder link connecting the satellite BS to the ground node is unavailable.

Example 25 includes the method of claim 23 or 24 or some other examples herein, wherein said determining, by the satellite BS, that the satellite BS is in the normal mode includes: determining that a feeder link connecting the satellite BS to the ground node is available.

Example 26 includes the method of any of claims 23-25 or some other examples herein, further including: sending, to the UE, an indication associated with S&F mode.

Example 27 includes the method of any of claims 23-26 or some other examples herein, wherein the indication is included in a system information block, a dedicated radio resource control (RRC) signaling, a medium access control (MAC) control element (CE), a DCI, or a non-access stratum (NAS) layer signaling.

Example 28 includes the method of any of claims 23-27 or some other examples herein, wherein the indication include a time associated with re-establishing a connection of the satellite BS with the ground node, or a duration associated with S&F mode.

Example 29 includes the method of any of claims 23-28 or some other examples herein, wherein the indication is included in a cell barring indication having a first flag and a second flag.

Example 30 includes the method of any of claims 23-29 or some other examples herein, wherein the UE is a legacy UE, and the method further includes: sending, to the legacy UE, an radio resource control (RRC) connection release message based on said determining that the satellite BS is in the S&F mode.

Another example may include an apparatus comprising logic, modules, or circuitry to perform one or more elements of a method described in or related to any of examples 1-30, or any other method or process described herein.

Another example may include a method, technique, or process as described in or related to any of examples 1-30, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-30, or portions thereof.

Another example includes a signal as described in or related to any of examples 1-30, or portions or parts thereof.

Another example may include a datagram, information element, packet, frame, segment, PDU, or message as described in or related to any of examples 1-30, or portions or parts thereof, or otherwise described in the present disclosure.

Another example may include a signal encoded with data as described in or related to any of examples 1-30, or portions or parts thereof, or otherwise described in the present disclosure.

Another example may include a signal encoded with a datagram, IE, packet, frame, segment, PDU, or message as described in or related to any of examples 1-30, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-30, or portions thereof.

Another example may include a computer program comprising instructions, wherein execution of the program by a processing element is to cause the processing element to carry out the method, techniques, or process as described in or related to any of examples 1-30, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
establishing a radio resource control (RRC) connection with a satellite base station (BS);
processing an indication, received from the satellite BS, associated with a store and forward (S&F) mode of the satellite BS; and
determining, based on the indication and a user equipment (UE) capability, whether to remain in an RRC connected state, to initiate a network access procedure, to monitor a paging channel, or to initiate a data transmission of a connection.

2. The method of claim 1, wherein the indication is included in a system information block (SIB), RRC signaling, a medium access control (MAC) control element (CE), a downlink control information (DCI), or a non-access stratum (NAS) signaling.

3. The method of claim 1, wherein the indication is included in a cell barring indication having a first flag and a second flag and the method further comprises:
determining, based on the first flag or the second flag, whether an access to a cell is restricted; and
determining, based on the first flag or the second flag, whether the satellite BS operates in the S&F mode.

4. The method of claim 1, wherein the indication includes a timer configuration having an S&F starting time, an S&F duration, an S&F periodicity, or an S&F mode of a neighbor cell.

5. The method of claim 1, wherein:
the UE capability indicates support for the S&F mode;
said determining, based on the indication and the UE capability, whether to remain in an RRC connected state, to initiate a network access procedure, to monitor a paging channel, or to initiate a data transmission of a connection includes determining to initiate a data transmission of a connection; and
the method further comprises restricting the connection to include a delay-tolerant connection.

6. The method of claim 5, wherein the connection is a packet data network (PDN) connection, a protocol data unit (PDU) session, a quality of service (QOS) flow, or a service data flow (SDF).

7. The method of claim 6, further comprising:
selecting the connection based on the indication; and
assigning a quality of service identifier (QI) associated with the S&F mode to the connection.

8. The method of claim 1, wherein a UE is an internet of things (IoT) UE and said establishing the RRC connection with the satellite BS comprises:
generating, for sending to a core network (CN), a registration request having capability information associated with the IoT UE supporting a satellite S&F mode;
processing a registration response received from the CN, the registration response to include configurations associated with the S&F mode; and
transitioning to the RRC connected state based on the registration response.

9. An apparatus, comprising:
processing circuitry to:
establish a radio resource control (RRC) connection with a satellite base station (BS);
process an indication received from the satellite BS, associated with a store and forward (S&F) mode of the satellite BS; and
determine, based on the indication and a user equipment (UE) capability, whether to remain in an RRC connected state, to initiate a network access procedure, to monitor a paging channel, or to initiate a data transmission of a connection; and
interface circuitry coupled with the processing circuitry, the interface circuitry to communicatively couple the processing circuitry with a component.

10. The apparatus of claim 9, wherein the indication is included in a system information block (SIB), an RRC signaling, a medium access control (MAC) control element (CE), a downlink control information (DCI), or a non-access stratum (NAS) signaling.

11. The apparatus of claim 9, wherein the indication is included in a cell barring indication having a first flag and a second flag, and the processing circuitry is further configured to:
determine, based on the first flag or the second flag, whether an access to a cell is restricted; and
determine, based on the first flag or the second flag, whether the satellite BS operates in the S&F mode.

12. The apparatus of claim 9, wherein the indication includes a timer configuration having an S&F starting time, an S&F duration, an S&F periodicity, or an S&F mode of a neighbor cell.

13. The apparatus of claim 9, wherein:
the UE capability indicates support for the S&F mode; and
to determine, based on the indication and the UE capability, whether to remain in an RRC connected state, to initiate a network access procedure, to monitor a paging channel, or to initiate a data transmission of the connection, the processing circuitry is configured to:
determine to initiate a data transmission of a connection; and
restrict the connection to include a delay-tolerant connection.

14. The apparatus of claim 13, wherein the connection is a packet data network (PDN) connection, a protocol data unit (PDU) session, a quality of service (QOS) flow, or a service data flow (SDF).

15. The apparatus of claim 14, wherein the processing circuitry is configured to:
select the connection based on the indication; and
assign a quality of service identifier (QI) associated with the S&F mode to the connection.

16. One or more non-transitory, computer-readable media having instructions that are to be executed to cause a processing circuitry to:
determine, based on determining that a feeder link connecting a satellite base station (BS) to a ground node is unavailable, that the satellite BS is in a store and forward (S&F) mode;
generate an indication associated with the S&F mode, the indication is to be sent to the UE;
process data received from a user equipment (UE); and
store the data.

17. The one or more non-transitory, computer-readable media of claim 16, wherein the instructions are to be executed to further cause the processing circuitry to:
determine, based on determining that the feeder link connecting the satellite BS to the ground node is available, that the satellite BS is in a normal mode; and
forward the stored data to a ground node.

18. The one or more non-transitory, computer-readable media of claim 16, wherein the indication is included in a system information block, a dedicated radio resource control (RRC) signaling, a medium access control (MAC) control element (CE), a downlink control information (DCI), or a non-access stratum (NAS) layer signaling.

19. The one or more non-transitory, computer-readable media of claim 16, wherein the indication includes a time associated with re-establishing a connection of the satellite BS with the ground node, or a duration associated with the S&F mode.

20. The one or more non-transitory, computer-readable media of claim 16, wherein the indication is included in a cell barring indication having a first flag and a second flag.
